(19) United States
(12) Patent Application Publication
(10) Pub. No.: US 2023/0008551 A1
(43) Pub. Date: Jan. 12, 2023

(54) MACHINE FOR PRINTING INFORMATION ON A CONTAINER

(71) Applicant: SMI S.P.A., Bergamo (IT)

(72) Inventors: Angelo NAVA, Bergamo (IT); Fabio CHIESA, Bergamo (IT); Ivan CORTINOVIS, Bergamo (IT)

(21) Appl. No.: 17/858,935

(22) Filed: Jul. 6, 2022

(30) Foreign Application Priority Data
Jul. 7, 2021 (IT) 102021000017858

(51) Int. Cl. B41F 17/08; B65C 9/46

(52) U.S. Cl. CPC B41F 17/08; B65C 9/46

(57) ABSTRACT

The present invention relates to the field of packaging liquids or semi-liquids in containers, and in particular, to a machine provided with a system for printing information directly on a container or label applied to said container.

In particular, the invention relates to a machine (1) for printing information on a container or blank label applied to said container, comprising:
at least one rotary information printing station (2, 2′);
a system (3) for feeding containers to said at least one rotary information printing station (2, 2′);
a system (4) for picking the printed containers from said at least one rotary information printing station (2, 2′).

### DESCRIPTION

### Technical Field of the Invention

The present invention relates to the field of packaging liquids or semi-liquids in containers, and in particular, to a machine provided with a system for printing information directly on a container or label applied to said container.

### Background Art

In the field of packaging liquids and semi-liquids in containers, the labeling step is an important operation usually performed by labeling machines which apply preformed labels or singularized labels from a reel in a stage immediately prior to the application to the container.

Machines adapted to print information directly on already-applied blank labels, or even on the surface of the container itself, thus without needing to physically apply a label, have recently been suggested. The latter solution has the advantage of saving the label material, as well as the label application equipment in the machine.

However, such online printing machines are characterized by low productivity, which hinders the diffusion thereof in large industrial production environments.

Therefore, the need exists to provide a machine for printing information on a container or blank label applied to said container, which is characterized by high productivity.

### SUMMARY OF THE INVENTION

The above need is met by a machine for printing information on a container or blank label applied to said container, as defined in the appended claims, the definitions of which form an integral part of the present description.

The present invention relates to a machine for printing information on a container or blank label applied to said container, comprising:
at least two rotary information printing stations placed in series;
a system for feeding containers to said at least two rotary information printing stations;
a system for picking the printed containers from said at least two rotary information printing stations.

The container may be of any type and material, such as a plastic container, a carton, a glass container, and cans, for example.

The invention further relates to a method of directly printing information on containers or blank labels applied to said containers, comprising the following steps:
providing a printing machine as defined in any one of claims 1 to 10;
in at least one first printing station, a plurality of moving steps for releasing a container to be printed from a system for feeding said container to the respective carousel, and a plurality of moving steps for releasing a printed container from said carousel to a container picking system;
in at least one second printing station, a plurality of moving steps for releasing a container to be printed from the system for feeding said container to the respective carousel, and a plurality of moving steps for releasing a printed container from said carousel to the container picking system;
a plurality of stationary printing steps and a plurality of stationary drying steps of printed containers in the carousel of said at least one first printing station and said at least one second printing station, where in said stationary printing and drying steps, the container is rotatable on the vertical axis thereof;
and where the at least one first printing station and the at least one second printing station are activated in an alternating and offset manner, so that the at least one first printing station picks the odd containers and the at least one second printing station picks the even containers, or vice versa, and where said at least one first printing station and said at least one second printing station alternate moving and stationary steps.

Further features and advantages of the present invention will become more apparent from the description of some embodiments, given by way of non-limiting example herein below.

### BRIEF DESCRIPTION OF THE DRAWINGS

FIG. 1 is a simplified perspective view of the machine according to the present invention;

FIG. 2 is a side view of the machine in FIG. 1;

FIG. 3 is a top view of a detail of the machine in FIG. 1;

FIG. 4 is a simplified perspective view of a detail of the machine in FIG. 1;

FIG. 5 is a simplified sectional perspective view of a different detail of the machine in FIG. 1;

FIG. 6 is a top view of a detail of the machine in FIG. 1;

FIGS. 7A, 7B and 7C are diagrammatic top views of three different configurations of the machine according to the invention;

FIGS. 8i-8xvdiagrammatically show an operating sequence of the machine of the invention.

### DETAILED DESCRIPTION OF THE INVENTION

With reference to the drawings, the present invention relates to a machine, indicated as a whole by numeral 1, for printing information on a container or blank label applied to said container, comprising:
at least two rotary information printing stations 2, 2′ placed in series;
a system 3 for feeding containers to said at least two rotary information printing stations 2, 2′;
a system 4 for picking the printed containers from said at least two rotary information printing stations 2, 2′.

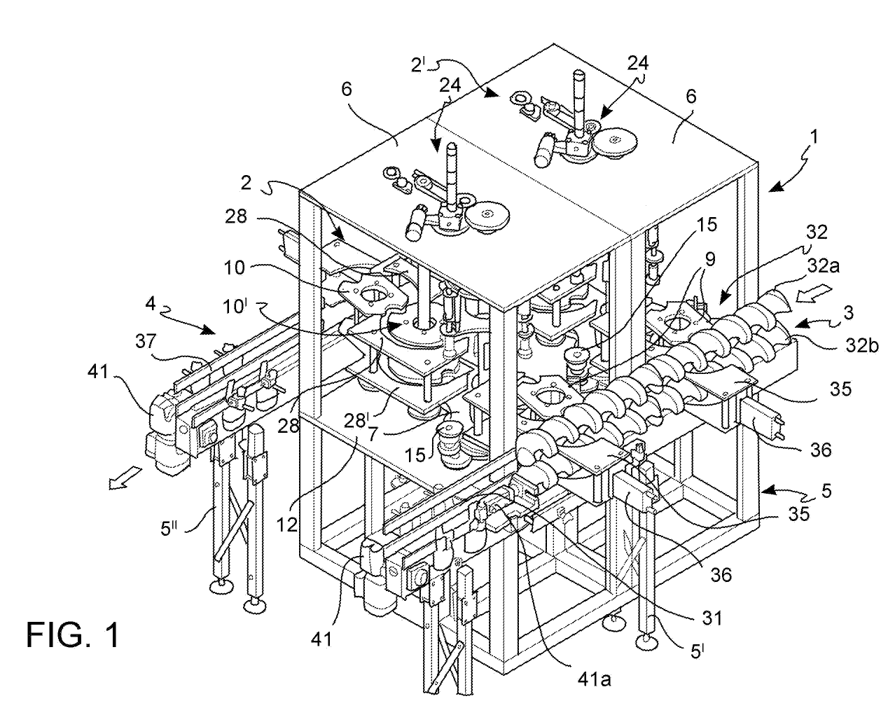

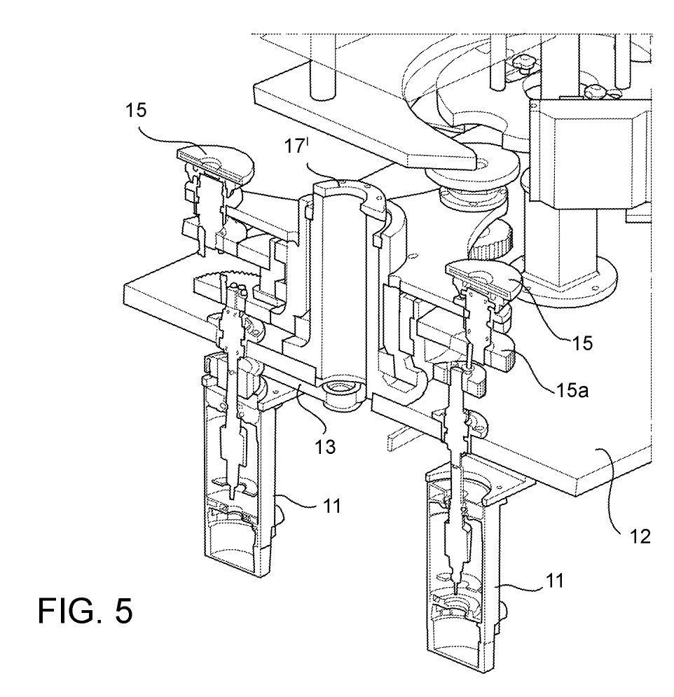

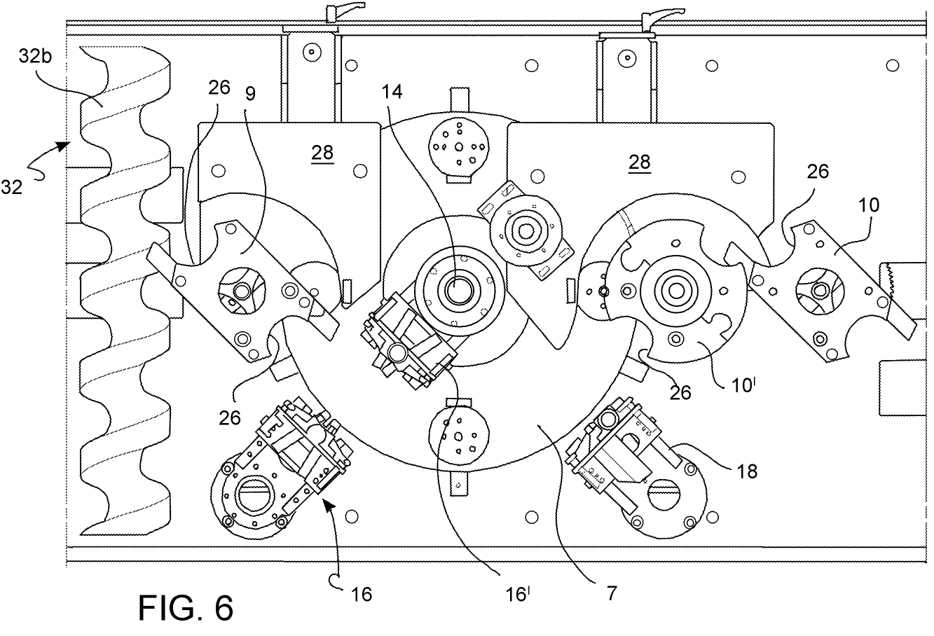

As shown in FIGS. 1 to 6, machine 1 comprises a frame 5 closed at the top by one or more support plates 6, said frame 5 and said support plates 6 being adapted to carry and support the rotating printing stations 2, 2′.

In the embodiment in FIGS. 1-6, each of the rotating printing stations 2, 2‘ comprises a carousel 7, a container retaining system 8, a star 9 for transferring the containers entering the carousel 7, and one or more stars 10, 10’ for transferring the containers output from carousel 7.

Carousel 7 is moved by specific drives 11 placed on one or more lower plates 12, which transmit the motion to a central shaft 14 by means of a drive mechanism 13, comprising for example a belt drive.

Carousel 7 rotationally supports rotating disks 15 configured to carry, at the base, the containers being processed on carousel 7. The rotating disks 15 are also set in rotation by the drives 11. A drive and reduction system 15a is configured for this purpose.

The drawings show four rotating disks 15, but the number thereof depends on the size of carousel 7, which may be adapted to the various production needs.

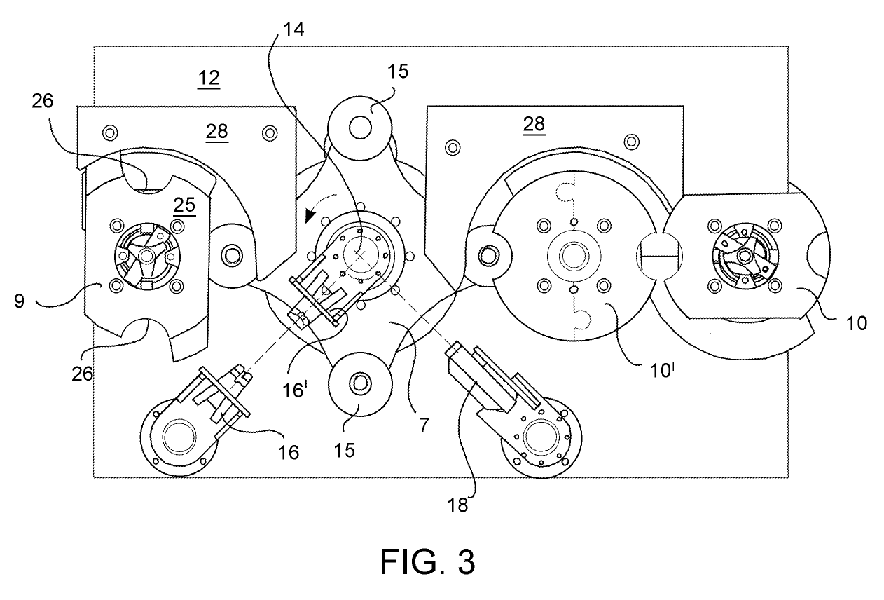

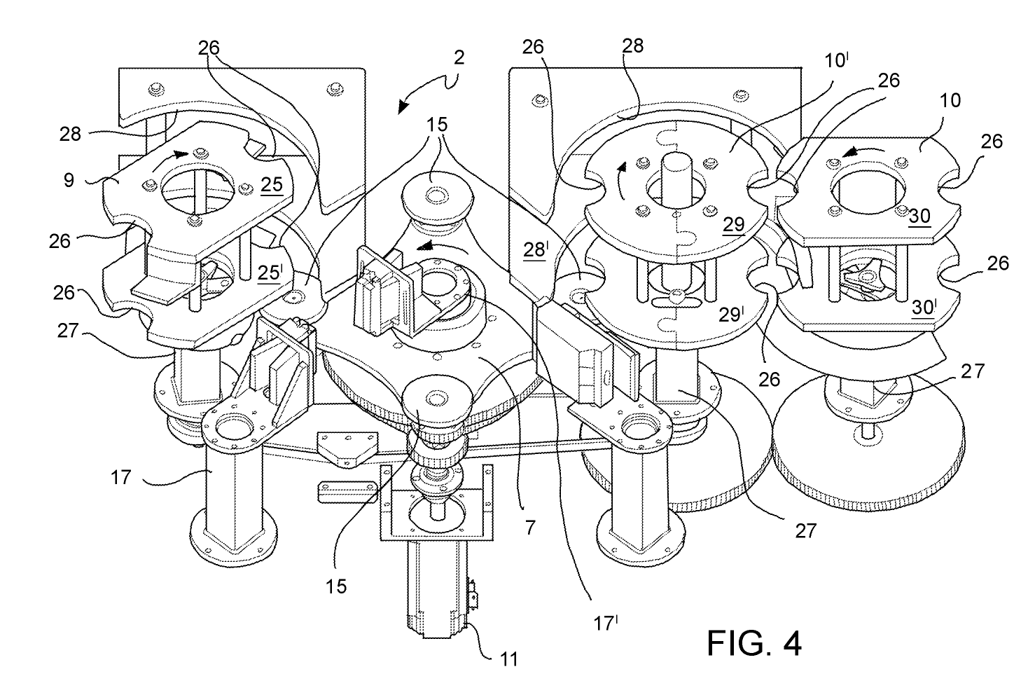

As better shown in FIGS. 3 and 4, printing heads 16, 16′ and a printed information drying head 18, such as an infrared lamp, are associated with carousel 7.

The printing heads 16, 16′ are placed in fixed position and facing one another. In particular, a first printing head 16 is placed on a support element 17 outside the carousel 7, while the second printing head 16′ is placed on a sleeve 17′ externally coaxial to shaft 14. Thereby, the container, e.g., a bottle, is positioned on a rotating disk 15 between the two printing heads 16, 16′ during the printing step.

The printing heads 16, 16′ are of the inkjet type.

The drying head 18 is placed outside the carousel 7 in a fixed and offset position with respect to the first printing head 16. In particular, the drying head 18 is placed downstream of the printing heads 16, 16′ with respect to the rotation direction of carousel 7 (shown by the arrow in FIG. 3).

The offset angle α between the printing heads 16, 16′ and the drying head 18 depends on the geometry of carousel 7, and in particular, on the number of disks 15, each corresponding to a container being processed. In the example shown in the drawings, the offset angle α is 90°.

The container retaining system 8 comprises a central shaft 19 from which arms 20 radially depart, which arms carry stop members 21 ending at the bottom with bell-like elements 22 configured to be positioned on the mouth of the containers and apply a retaining pressure to the containers, which thus are retained on the rotating disks 15. The stop members 21 or the bell-like elements 22 are rotatably idle so as to follow the rotation of the container on the rotating disk 15.

A cam 23 lowers or raises the stop members 21, when a container enters on a rotating disk 15 and when a container exits from a rotating disk 15, respectively.

A conventional-type system 24 for adjusting the height of the retaining system 8 is placed above the support plate(s) 6 so as to adapt it to the various dimensions of the containers being processed.

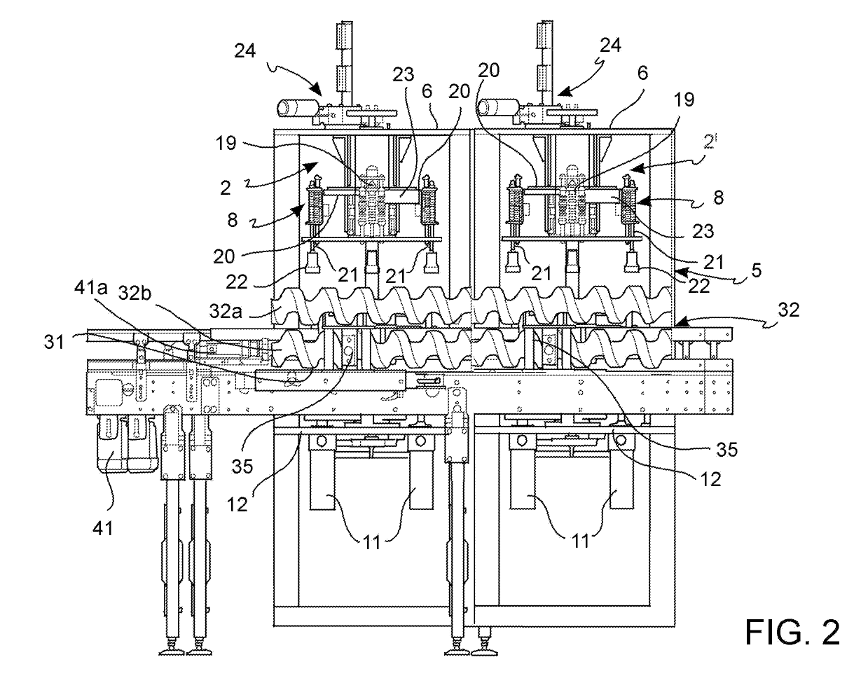

The retaining system 8 is rotationally integral with carousel 7 because the central shaft 19 is fastened to the shaft 14 of carousel 7, as shown in FIG. 2.

The star 9 for transferring the containers entering carousel 7 comprises an upper plate 25 and a lower plate 25′, which are integrally set in rotation on a support element 27. Each of the plates 25, 25′ comprises recesses 26 (two in the example in the drawings) which are vertically aligned and configured so as to guide and retain, in conjunction with a respective counter-side 28, 28′, a container transiting on the transfer star 9. The counter-sides 28, 28′ are placed in fixed position between the container feeding system 3 and the carousel 7.

The provision of the upper 25 and lower 25′ plates aims to improve the retention and stability of the containers being transferred.

In the embodiment shown in FIGS. 1-6, each rotating printing station 2, 2′ comprises two stars 10, 10′ for transferring the containers output from carousel 7. The transfer stars 10, 10′ are configured as the input transfer star 9 and therefore comprise respective upper plates 29, 30 and respective lower plates 29′, 30′, all provided with recesses 26 for guiding and retaining the containers.

The transfer stars 10, 10′ are associated with respective retaining sides 28, 28′ (for the outermost transfer star 10, one retaining wall 28 is shown in FIG. 1).

The transfer stars 10, 10′ are rotatably mounted on respective support elements 27.

The input and output transfer stars 9, 10, 10′ are moved by the same drives 11 as the carousel 7 and the rotating disks 15 or, in a different embodiment, by dedicated independent drives.

The container feeding system 3 is placed outside frame 5 and preferably rests on a separate base 5′. It comprises a conveyor 31, conventionally a belt conveyor, with which a screw separator 32 is associated at the top. The containers rest on and are guided by conveyor 31 while the lateral surface thereof is engaged in the grooves by the screw separator 32 which determines the pitch thereof and preserves the vertical stability thereof.

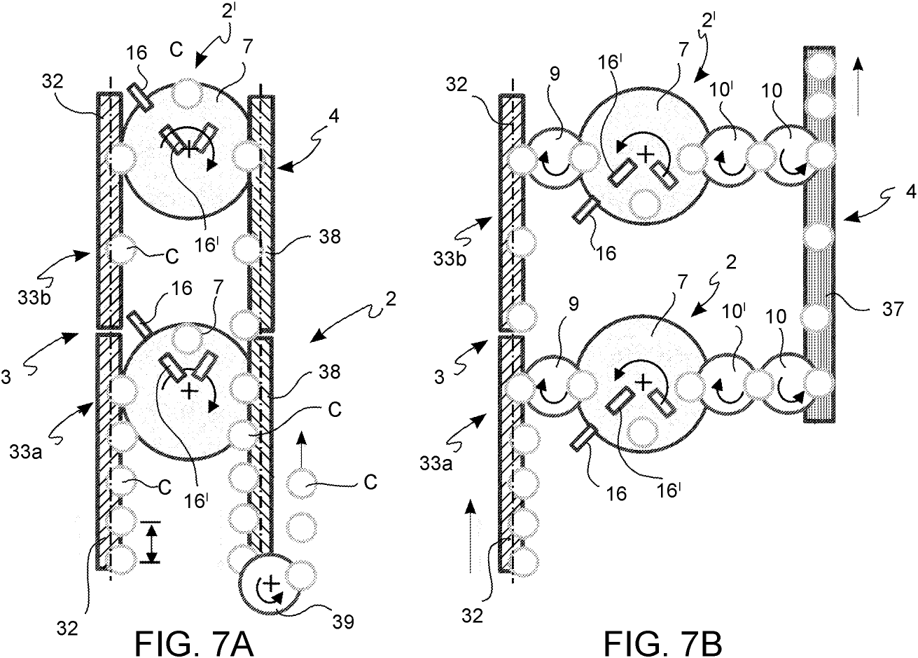

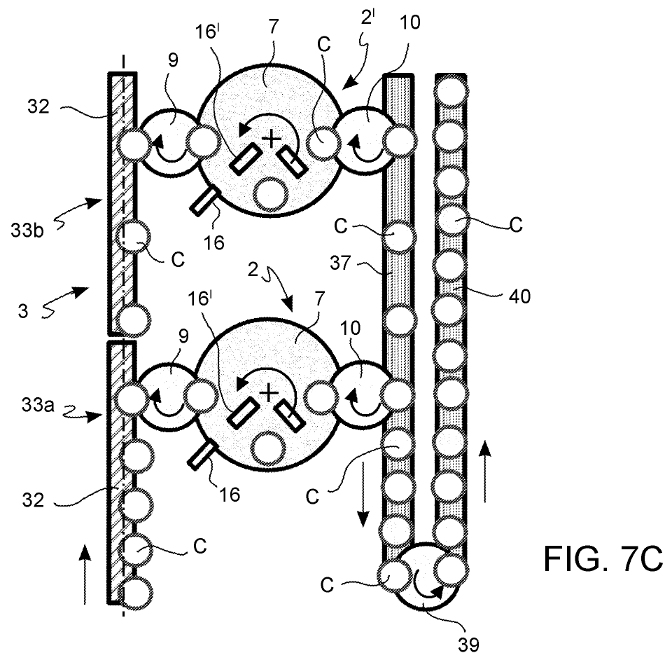

The screw separator 32 consists of an upper screw 32a and a lower screw 32b which are configured to vertically carry the containers. With reference to FIGS. 7A-7C, the screws 32a, 32b comprise a first variable pitch section 33a so as to bring the containers to the pitch required by the printing station 2, 2′, and a second fixed pitch section 33b corresponding to the pitch required by the printing station 2, 2′. As shown in FIGS. 7A-7C, the first and second sections 33a, 33b may be separate, but there may be a single screw separator 32 in various embodiments.

The feeding system 3 further comprises a diverter member 35 for each of the printing stations 2, 2′. The diverter member 35 is placed at the star 9 for transferring the containers entering carousel 7 and is aligned thereto on the opposite side, i.e., the outer side, of the screw separator 32. The diverter member 35 comprises a pusher 36, e.g., a pneumatic plunger, which pushes the container towards the corresponding recess 26 when it faces the feeding system 3 so as to promote the gripping of the container by the transfer star 9.

The container picking system 4 is placed outside the frame 5 and preferably rests on a separate base 5′. In the embodiment shown in FIGS. 1-6 and in FIGS. 7B and 7C, it comprises a conveyor 37, conventionally a belt conveyor. In other embodiments, as shown in FIG. 7A, the picking system 4 comprises a screw conveyor 38 which can be made in a single section or, as shown in the drawing, in two distinct sections.

As mentioned, the embodiment in FIGS. 1-6 and FIG. 7B comprises one input transfer star 9 and two output transfer stars 10, 10′. Thereby, both the feeding of the containers C to carousel 7 and the picking thereof are performed along the same direction indicated by the arrows at the feeding 3 and picking 4 systems.

In the embodiment in FIG. 7A, transfer stars are not arranged between the feeding system 3 and carousel 7 and between carousel 7 and the picking system 4, but the transfer occurs directly by the screw separator 32 and the screw conveyor 38, respectively. However, in this case, the feeding direction of the containers C and the picking direction are opposite. If required, a transfer star 39 is placed downstream of the screw conveyor 38 so as to invert the picking direction of the containers C.

The embodiment in FIG. 7C instead provides for one input transfer star 9 and a single output transfer star 10. Also in this case, as for the embodiment in FIG. 7A, the feeding direction of the containers C and the picking direction are opposite. A transfer star 39 is placed downstream of conveyor 37 so as to invert the picking direction of the containers C, depositing them on a second conveyor 40, for example a belt conveyor as well.

The feeding 3 and picking 4 systems are preferably moved by independent drives 41, 41a (FIGS. 1 and 2).

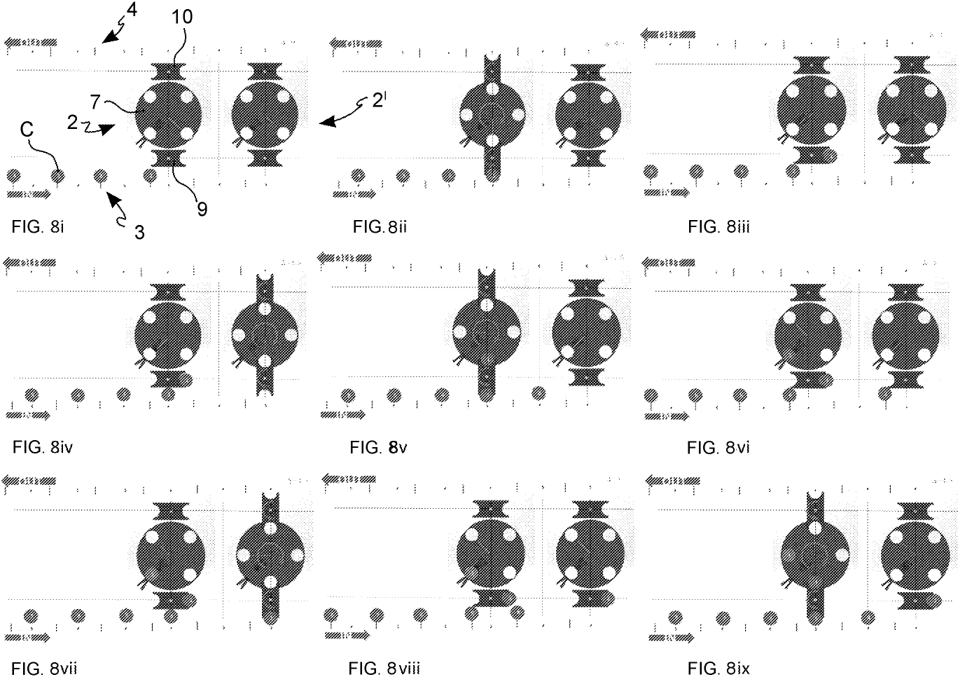

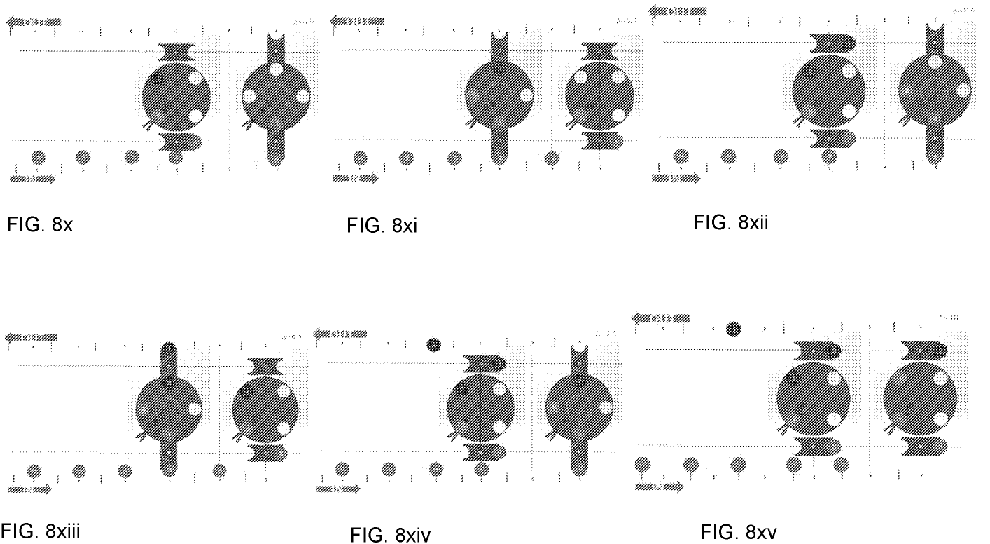

The operation of the machine for printing information according to the invention will now be described with reference to FIGS. 8i-8xv. Such drawings show the machine 1 in a simplified and diagrammatic manner.

In the machine 1 according to the invention, the movement of the feeding system 3 and the picking system 4 is continuous, while the carousel 7 and the transfer stars 9, 10 move in a discontinuous manner.

In particular, FIG. 8i shows a step in which the containers C approach the first printing station 2, which from stationary begins to rotate.

FIG. 8ii shows a step in which the first container C is engaged by the transfer star 9. Carousel 7 has also rotated by 45°.

FIG. 8iii shows a next step in which the transfer star 9 and the carousel 7 rotate (the first by 90°, the second by 45°) .

FIG. 8iv shows a next step in which the first printing station 2 is stationary, thus allowing the second container C fed towards the second printing station 2′ – which in the meantime begins moving – to pass.

FIG. 8v shows a next step in which the first printing station 2 is brought to the position of releasing the first container C from the transfer star 9 to carousel 7, and at the same time the opposite recess 26 engages the third container C sliding on belt 3.

FIG. 8vi shows a next step in which the first container in the first printing station 2 reaches the corresponding position of the printing heads 16, 16′, while the second printing station 2′ is stationary.

FIG. 8vii shows a next step in which the first printing station 2 is stationary and in which the information is printed on container C or on a blank label applied to container C. The second printing station 2′ is moving so that the related transfer star 9 engages the second container C that in the meantime has reached the input position in the respective carousel 7.

FIG. 8ix shows a next step in which the third container C is transferred to the carousel 7 of the first printing station 2, and at the same time the respective transfer star 9 engages the fifth container C. The fourth container C moves towards the second printing station 2′, which is stationary in that moment.

FIG. 8x shows a next step in which the third container C in the first printing station 2 reaches the printing position and the first container C reaches the drying position. The second container C is transferred to the carousel 7 of the second printing station 2′ and the respective transfer star 9 engages the fourth container, which has reached the input position.

FIG. 8xi shows a next step in which the first container C in the first printing station 2 is engaged by the transfer star 10 and the fifth container C is released to carousel 7. The second container C in the second printing station 2′ reaches the printing position and then, with the carousel 7 being stationary, the information is printed on such a container C.

FIG. 8xii shows a next step in which the fifth container C in the first printing station 2 reaches the printing position (and then the information is printed on said container) and the third container C reaches the drying position. The fourth container C in the second printing station 2′ is released to carousel 7, and in the meantime the sixth container C is engaged by the respective transfer star 9.

FIG. 8xiiii shows a next step in which the first container C in the first printing station 2 is released to the picking system 4, and at the same time the third container C is engaged by the respective transfer star 10; the seventh container C is released to carousel 7, and at the same time the ninth container C is engaged by the respective transfer star 9. The fourth container C in the second printing station 2′ reaches the printing position and the second container C reaches the drying position.

FIG. 8xiv shows a next step in which the seventh container C in the first printing station 2 reaches the printing position and the fifth container C reaches the drying position. The sixth container C in the second printing station 2′ is released to carousel 7, and at the same time the eighth container C is engaged by the respective transfer star 9; the second container C is engaged by the transfer star 10.

FIG. 8sv shows a next step in which the seventh container C in the first printing station 2 is printed and the fifth container 5 undergoes drying. The sixth container C in the second printing station 2′ reaches the printing position and the fourth container C reaches the drying position.

The process continues as described above, repeating the various steps, and therefore comprises:
in at least one first printing station 2, a plurality of moving steps for releasing a container C to be printed from a system 3 for feeding said container C to the carousel 7, and a plurality of moving steps for releasing a printed container C from the carousel 7 to a system 4 for picking the containers C;
in at least one second printing station 2′, a plurality of moving steps for releasing a container C to be printed from the system 3 for feeding said container C to the carousel 7, and a plurality of moving steps for releasing a printed container C from the carousel 7 to the system 4 for picking the containers C;
a plurality of stationary printing steps and a plurality of stationary drying steps of printed containers C in the carousel 7 of said at least one first printing station 2 and said at least one second printing station 2′, where in said stationary printing and drying steps, the container C is rotatable on the vertical axis thereof;
and where the at least one first printing station 2 and the at least one second printing station 2′ are activated in an alternating and offset manner, so that the at least one first printing station 2 picks the odd containers and the at least one second printing station 2′ picks the even containers, or vice versa, and where said at least one first printing station 2 and said at least one second printing station 2′ alternate moving and stationary steps.

As mentioned above, the machine for printing information on containers comprises at least two printing stations placed in series, but a machine comprising three or more printing stations can be provided according to production needs. With each further printing station, productivity increases by 50% with respect to the embodiment with two printing stations 2, 2′.

Depending on the printing head and ink used, the information can be directly printed on the container (which may be made of plastic, such as PLA or PET, or glass) or on a blank label applied to the container.

Therefore, the present invention achieves the preset objects by providing a direct printing system which replaces a labeler, resulting in the saving of adhesive and label material, while allowing a high productivity that can be adjusted as needed.

It is apparent that only some particular embodiments of the present invention have been described, to which those skilled in the art will be able to make all changes required for the adaptation thereof to particular applications, without however departing from the scope of protection of the present invention.

What we claim is:

1. A machine for printing information on a container or blank label applied to said container, comprising:
at least one rotary information printing station;
a system for feeding containers to said at least one rotary information printing station;
a system for picking the containers printed by said at least one rotary information printing station.

2. The machine according to claim 1, comprising at least two rotary information printing stations placed in series.

3. The machine according to claim 1, wherein each of the at least one or at least two rotating printing stations comprises or consists of a carousel, a container retaining system which is rotationally integral with the carousel, optionally a star for transferring the containers entering the carousel, and optionally one or more stars for transferring the containers output from the carousel.

4. The machine according to claim 3, wherein the carousel rotationally supports a plurality of rotating disks configured to carry, at the base, the containers being processed on the carousel, and wherein the container retaining system comprises a central shaft from which arms radially depart, which arms carry stop members ending at the bottom with bell-like elements configured to be positioned on the mouth of the containers and apply a retaining pressure to the containers on the rotating disks.

5. The machine according to claim 3, wherein the carousel comprises printing heads and a printed information drying head, wherein the printing heads are placed in fixed position and facing one another, and wherein the drying head is placed in an offset, fixed position with respect to the printing heads.

6. The machine according to claim 3, wherein the star for transferring the containers entering the carousel, if present, comprises or consists of an upper plate and a lower plate which are integrally placed under rotation on a support element, each of the plates comprising recesses which are vertically aligned and configured so as to guide and retain, in conjunction with respective counter-sides, a container transiting on the transfer star.

7. The machine according to claim 3, wherein the at least one star for transferring the containers output from the carousel, if present, comprises or consists of respective upper plates and respective lower plates, vertically aligned, said upper plates and lower plates being provided with vertically aligned recesses for guiding and retaining the containers.

8. The machine according to claim 1, wherein the container feeding system comprises or consists of a conveyor, preferably a belt conveyor, with which a screw separator is associated at the top, so that the containers rest on and are guided by the conveyor while the lateral surface thereof is engaged by the screw separator which determines the pitch thereof and preserves the vertical stability thereof.

9. The machine according to claim 8, wherein the screw separator comprises or consists of an upper screw and a lower screw which are configured to vertically carry the containers, wherein the screws comprise a first variable pitch section so as to bring the containers to the pitch required by the printing station, and a second fixed pitch section corresponding to the pitch required by the printing station.

10. The machine according to claim 8, wherein the feeding system further comprises a diverter member for each of the printing stations, the diverter member being placed at the star for transferring the containers entering the carousel and being aligned thereto on the opposite side, i.e., the outer side, of the screw separator, and wherein the diverter member comprises a pusher, for example a pneumatic plunger, which pushes the container towards the corresponding recess when it faces the feeding system so as to promote the gripping of the container by the transfer star.

11. The machine according to claim 1, wherein the container picking system comprises or consists of a conveyor, preferably a belt conveyor, or a screw conveyor.

12. A method of directly printing information on containers or blank labels applied to said containers, comprising the following steps:
providing a printing machine as defined in claim 2;
in at least one first printing station, a plurality of moving steps for releasing a container to be printed from a system for feeding said container to the respective carousel, and a plurality of moving steps for releasing a printed container from said carousel to a container picking system;
in at least one second printing station, a plurality of moving steps for releasing a container to be printed from the system for feeding said container to the respective carousel, and a plurality of moving steps for releasing a printed container from said carousel to the container picking system;
a plurality of stationary printing steps and a plurality of stationary drying steps of printed containers in the carousel of said at least one first printing station and of said at least one second printing station, wherein in said stationary printing and drying steps, the container is rotatable on the vertical axis thereof;
and wherein the at least one first printing station and the at least one second printing station are activated in an alternating and offset manner, so that the at least one first printing station picks the odd containers and the at least one second printing station picks the even containers, or vice versa, and wherein said at least one first printing station and said at least one second printing station alternate moving and stationary steps.
